(19) United States
(12) Patent Application Publication
(10) Pub. No.: US 2004/0202416 A1
(43) Pub. Date: Oct. 14, 2004

(54) Wavelength-division multiplexer or demultiplexer using expanded core fibers

(76) Inventor: James W. Horwitz, Santa Barbara, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/831,425

(22) Filed: Apr. 23, 2004

Related U.S. Application Data
(63) Continuation-in-part of application No. 10/602,486, filed on Jun. 24, 2003.
(60) Provisional application No. 60/391,258, filed on Jun. 24, 2002.

(51) Int. Cl. G02B 6/28; G02B 6/34

(52) U.S. Cl. 385/24; 385/37

(57) ABSTRACT

A wavelength-division multiplexer (WDM) or demultiplexer (WDDM) is disclosed. In this invention, the input fibers of a WDM or the output fibers of a WDDM all have end portions with expanded cores. The use of such fibers causes an increase in the spectral bandwidth of the instrument, compared to an instrument that uses standard single-mode fibers for these purposes. The use of expanded-core fibers allows larger alignment tolerances and reduces signal losses due to misalignment, diffraction and aberrations. An estimate is given of the ratio of the spectral bandwidth to the spectral spacing of adjacent channels.

### 1. CLAIM TO PRIORITY

This application is a continuation-in-part application of U.S. patent application Ser. No. 10/602,486, filed Jun. 24, 2003, which, in turn, claims priority to and benefit of U.S. Provisional Patent Application No. 60/391,258, filed on Jun. 24, 2002, both of which applications are entitled, “Wavelength Division Multiplexer or Demultiplexer Using Expanded Core Fibers,” and both of which applications are incorporated herein by reference in their entireties.

### 2. GOVERNMENTAL RIGHTS

The invention was made with Government support under Contract No. DASG60-98C-0062, awarded by the U.S. Army and contract No. DASG60-98-0108, also awarded by the U.S. Army. The government has certain rights in the invention.

### BACKGROUND OF THE INVENTION

3. The Field of the Invention

The present invention generally relates to optics, and more particularly, to a wavelength division multiplexer or demultiplexer using expanded core fibers.

4. Background of the Invention

The increasing demand for high-speed broadband communications has resulted in a rapid increase in fiber optic communications systems that require faster and more reliable components to interconnect associated optoelectronic devices of a network. One problem encountered with some conventional systems includes inefficient use of the full optical spectrum for communicating signals, and, hence, data. For example, FIG. 1 illustrates two conventional optical fibers having a core of diameter a surrounded by a cladding layer of diameter D. These two fibers are part of a line of several fibers that sends or receives spectrally dispersed light to or from a lens in a wavelength division module. The fibers are positioned so that the distance, b, between adjacent fibers is nearly constant. This distance is called the inter-fiber distance. These fibers are either the output fibers of a wavelength division demultiplexer (WDDM) or the input fibers of a wavelength division multiplexer (WDM).

With brief reference to FIG. 4, a typical demultiplexer is shown. Polychromatic radiation consisting of n distinct spectral bands passes through the input fiber, 406, to the focal plane, 414, of a well-corrected lens, 408. This lens 408 collimates the radiation and presents it to a diffraction grating, 402. The grating 402 produces angular spectral dispersion of the beam in the plane of the diagram. The lens 408 typically refocuses the beam in the same focal plane 414 as before, thus producing n images of the input fiber 406 spectrally dispersed in a linear fashion along the focal plane and in the plane of FIG. 4. Each image of the input fiber 406 will, if its associated spectral band consists of strictly monochromatic light, be a circle. A row of n output fibers A, B, . . . collects the light and sends the separated bands to n receivers. Only two of these fibers 410, 412 are shown in the diagram.

Turning back to FIG. 1, usually the diameters of the cores of all fibers have the same value, a. From the laws of paraxial optics, it follows that the magnification is −1, so that the geometrical images of the input fiber all have the same diameter, a. A multiplexer functions in an identical fashion as a demultiplexer, but the light travels in the opposite direction. The multiplexer has one output fiber and n input fibers.

Changes in the inter-fiber distance, b, may affect the light or optical signals propagating along the optical fibers. The wavelength λ of an optical signal changes in the direction of dispersion of the optical signal spectrum in a linear fashion over a short inter-fiber distance, b. As such, dλ/dx describes the rate of change of wavelength with distance x along a focal plane containing the ends of the output fibers of a WDDM or the input fibers of a WDM. The ratio of channel spectral width (bandwidth) Δλ to channel spectral spacing Δλ′ is known as the fill ratio, R, and is given by the equation

R=Δλ/Δλ′ (1)

By convolution of two identical circles along the direction of dispersion, it can be shown that the full width at half maximum Δλ of the spectral band collected by one of the demultiplexed fibers is

Δλ=ka, (2)

where k=0.808. This equation assumes that the input fiber core is uniformly illuminated, and that diffraction and lens aberrations are so small that they may be neglected for the purpose of (2). Thus, the fill ratio may be reasonably approximated by

R=k(a/b). (3)

For comparison purposes one can define the fill factor, F, as

$$F = \frac{a}{b} \qquad ( 4 )$$

so that

F=(1/k)Δλ/Δλ′). (5)

In these equations, F is the ratio of the core diameter to the physical spacing of adjacent output fibers in a WDDM, or of adjacent input fibers in a WDM. The variable F is seen by (5) to be directly proportional to the ratio of the bandwidth of a channel to the wavelength spacing of adjacent channels. For some typical single mode fibers, the value of a is 8.2 μm. For many single mode fibers the cladding diameter (D) is approximately 125 μm which means that b is usually no smaller than about 150 μm. The resulting fill factor would be approximately:

F=8.2 μm/150 μm=5.5% (6)

As such, single mode fibers may exhibit low fill factors, resulting in poor utilization of bandwidth.

The fill factor limitations of existing single mode fibers result in inefficient wavelength-division multiplexers and de-multiplexers, collectively termed wavelength-division modules. As is known, a multiplexer enables multiple carrier waves to be carried on a single transmission medium. In the case of optical networks, a multiplexer receives as input multiple signals operating at different frequencies and separated by some predetermined amount of frequency separation known as the channel spacing. This spacing is usually on the order of 25-200 GHz for multiplexers currently in production. The multiplexer combines these separate signals onto a single optical fiber so that the signals can be transmitted to a remote location. The de-multiplexer works in an opposite fashion, wherein the de-multiplexer separates polychromatic signals into a series of nearly monochromatic signals within narrow-bandwidth channels using a diffraction grating or other optical component(s). Each channel includes a center wavelength derived from the original optical signal.

With existing technologies, the core portion of the optical fibers is usually no more than 9 μm across. Having such a small aperture often requires expensive and time consuming alignment procedures to ensure that optical signals are focused onto the fiber core. All of the optical components must be very carefully fixed in place in order to achieve optical alignment and corresponding functionality of the optical device. Accordingly, it would be an advantage to have a system which is not subject to such constraints.

### BRIEF SUMMARY OF THE INVENTION

In accordance with teachings of the present invention, an optical system such as a wavelength division multiplexer (WDM) or demultiplexer (WDDM) for communicating optical signals is disclosed. All of the output fibers of a WDDM (or the input fibers of a WDM) have end portions with expanded core diameters. The core of the input fiber of a WDDM (or the output fiber of a WDM) need not be expanded, although it usually is in order to make numerical apertures of the input and output sides be equal. These expanded core diameters enable less complicated alignment of the optical components of the wavelength division module.

In accordance with one aspect of the present invention, an optical system such as a WDM or WDDM for communicating optical signals is disclosed. All of the output fibers of the WDDM or the input fibers of the WDM have end portions with expanded cores, and these ends may be in the focal plane of a lens. The optical system may further include a grating or a prism optically coupled to the lens and operable, in conjunction with the lens, to communicate optical signals between the input fiber and the output fibers of the WDDM or between the input fibers and the output fiber of the WDM. The system may include one or more mounts to position the expanded core optical fibers to exhibit an increased fill factor for communicating the optical signals.

In accordance with another aspect of the present invention, disclosed is an optical network that includes a WDM or WDDM. The WDM or WDDM that forms part of the network has the components that were described in the preceding paragraph. The network itself usually further includes at least two optical fibers that communicate information between one or more initiating points and one or more destination points.

In this manner, the present invention provides an optical system exhibiting minimal signal loss through the use of optical transmission mediums that result in increased fill factors for communicating optical signals. The present invention also provides optical systems using tapered core mediums for use with conventional single mode optical fibers for receiving and transmitting optical signals. By using expanded core fibers, an increase in the area of the core is realized. This increased area makes it easier to position and align the optical components, thus saving both time and money in the construction of these components, and overcoming the shortcomings outlined above.

These and other objects and features of the present invention will become more fully apparent from the following description and appended claims, or may be learned by the practice of the invention as set forth hereinafter.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the ends of two adjacent parallel optical fibers;

FIG. 2 illustrates one embodiment of a wavelength division demultiplexer or multiplexer using an expanded core optical fiber according to one aspect of the present invention;

FIG. 3 illustrates one embodiment of an expanded core optical fiber according to one aspect of the present invention in which the expanded core portion is a tapered core;

FIG. 4 illustrates another embodiment of a wavelength division demultiplexer (WDDM) module employing tapered core single mode optical fibers according to the present invention; and

FIG. 5 illustrates an optical network using expanded core optical fibers in WDM and WDDM applications according to the present invention.

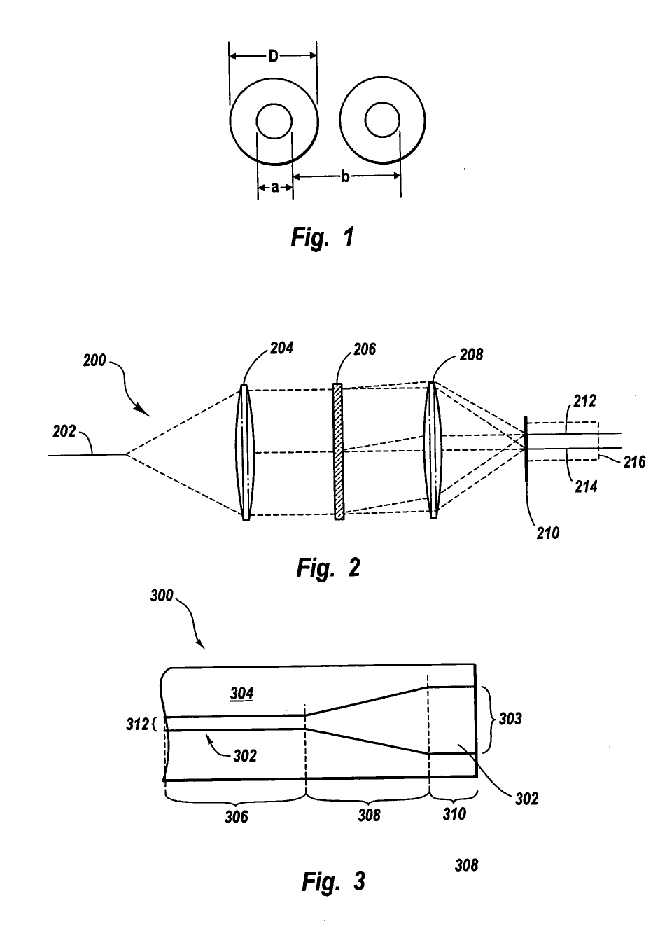

### DETAILED DESCRIPTION OF THE EXEMPLARY EMBODIMENTS

Generally, the present invention relates to increasing fill factors for single mode optical fibers used to communicate multiple wavelength optical signals. The present invention will be described in the context of an optical system, such as, but not limited to, a wavelength division multiplexer (WDM) or demultiplexer (WDDM). As described above, a multiplexer enables multiple carrier waves, each separated by between about 25-200 GHz channel spacings, to be carried on a single transmission medium. The multiplexer combines these separate signals onto a single optical fiber so that the signals can be transmitted to a remote location. Although reference is made to a specific spacing range, one skilled in the art will understand that other spacing ranges are appropriate.

A WDDM operates in combination with the WDM. The WDDM is, however, typically located at a location remote from the corresponding WDM and de-multiplexes the combined optical signal. More specifically, the WDDM separates polychromatic signals into a series of nearly monochromatic signals within narrow-bandwidth channels using a diffraction grating or other optical component(s). Each channel includes a center wavelength derived from the original optical signal. In this manner, multiple wavelength signals may be communicated from one optical fiber to multiple optical fibers.

The operating characteristics of a WDM improve by the provision of a set of input fibers, the ends of which have increased core diameters. Similarly, the operating characteristics of a WDDM improve by the provision of a set of output fibers, the ends of which have increased core diameters. These improvements occur because increases in core sizes cause increases in fill factors of adjacent fibers, as shown by equation (4). The end portion of the core of each of these fibers has a greater diameter than does the remaining portion, and allows a greater bandwidth of optical signals to be propagated through the instrument, as shown by equation (5). Further, the increased core diameters ease the task of aligning the fibers to the rest of the instrument.

Reference will now be made to FIGS. 2-5 to describe exemplary configurations of the present invention. It is to be understood that the drawings are diagrammatic and schematic representations of presently illustrated embodiments, and are not limiting of the present invention, nor are they necessarily drawn to scale.

FIG. 2 illustrates one embodiment of an optical system using an expanded core optical fiber according to teachings of the present invention. The optical system may be realized, for example, as a WDM or WDDM and is illustrated generally at 200. In the illustrative configuration, system 200 includes a diffraction grating 206 optically coupled to a first lens 204 and a second lens 208. Although reference is made to the WDM or WDDM using a diffraction grating, one skilled in the art will appreciate that WDMs and WDDMs may utilize other optical components to separate or combine one or more optical signals. For instance, the optical signals may be separated or combined by a prism instead of a grating, or the functions of the lens and the dispersive element may be combined.

In a WDDM configuration, the first lens 204 is positioned within an optical path between an input fiber 202 and grating 206. The second lens 208 is optically coupled to diffraction grating 206 and directs electromagnetic radiation or light incident on second lens 208 to first output fiber 212 and second output fiber 214. The lenses 204 and 208 may have various configurations so long as they function to direct electromagnetic radiation or light toward diffraction grating 206 or focus electromagnetic radiation or light received from diffraction grating 206 upon focal plane 210 for each respective output fiber 212 and 214. Similarly, in a WDM configuration, light from several input fibers is combined and directed to one output fiber.

In a WDDM configuration the ends of the first and second output fibers 212 and 214 are maintained within the focal plane 210. This may be achieved by a mount 216, such as a receiver, a transceiver, or other optical module, as known to those skilled in the art. Similarly, in a WDM configuration, the ends of the input fibers are maintained within the focal plane 210, which may be achieved by a mount 216, such as a transmitter, a transceiver or other optical module.

In a WDDM configuration, first lens 204 collimates the electromagnetic radiation or light from input fiber 202 and communicates the same to grating 206. Grating 206 separates the electromagnetic radiation or light into separate optical signals or channels having constituent wavelengths and sends an angularly dispersed spectrum to second lens 208. Second lens 208 focuses a respective linearly dispersed spectrum onto focal plane 210, with first and second output fibers 212 and 214 each receiving a different portion of the spectrum (i.e. a separate channel). For example, first fiber 212 and second fiber 214 receive selected portions of a multiple wavelength optical signal transmitted from input fiber 204. As before, a WDM functions in a reversed manner, and combines radiation from several input fibers onto one output fiber.

In a WDDM configuration the first output fiber 212 and the second output fiber 214 may be single mode fibers that have end portions with expanded cores. Similarly, in a WDM configuration, the first and second input fibers may have end portions with expanded cores. For example, the single mode fiber may include an end portion having a tapered expanded core (EC) that increases fill factors relative to single mode fibers having non-expanded cores. Stated another way, the ends of fibers 212 and 214 include the tapered EC end portion that allows a greater bandwidth of electromagnetic radiation to be received by the respective fiber and enables simple aligning and positioning of fibers 212 and 214 than compared against existing non-expanded optical fibers. As such, efficient communication of optical signals may be realized by increasing the fill factor for systems employing single mode fibers with expanded cores.

FIG. 3 illustrates one embodiment of an expanded core optical fiber formed in accordance with teachings of the present invention. The portion of optical fiber 300 shown in FIG. 3 includes core 302 and cladding layer 304. Core 302 may include first portion 306, second portion 308, and third portion 310 formed in accordance with teachings of the present invention. First portion 306 has a diameter 312 corresponding with a typical single mode optical fiber. Third portion 310 may have a diameter 303 which is substantially larger than diameter 312. Second portion 308 may include a tapered configuration, with the diameter of second portion 308 adjacent first portion 306 being substantially similar to the diameter of first portion 306 and the diameter of second portion 308 adjacent third portion 310 being substantially similar to the diameter of third portion 310. As such, the optical fiber 300 of FIG. 3 may also be referred to as a tapered core optical fiber.

In one embodiment, optical fiber 300 may be a single mode optical fiber with first portion 306 including an optical fiber diameter 312 of approximately 8.2 micrometer (μm) and third portion 310 including a diameter 303 of approximately 40 μm. During use, an optical signal may be communicated via optical fiber 300 using an end portion with an expanded core as part of third portion 310 such that a desired fill ratio may be realized. For example, two single mode optical fibers (not expressly shown) may include end portions having expanded cores of approximately 40 μm and positioned with a spacing of 150 μm between each fiber. As such, a fill factor of greater than approximately twenty percent may be realized given F=40/150 is approximately 26.7% from equation (4) above. This is a five-fold increase in the fill factor associated with the WDM or WDDM system of the prior art.

Although reference is made to specific diameters of the core of the optical fiber and the distance between adjacent optical fibers, one skilled in the art will understand that various diameters and distances may be possible to achieve the desired fill factor. For instance, the diameter of the core may range from about 8 μm to about 10 μm prior to core expansion, while the distance between adjacent optical fibers or the cores of the optical fibers is usually no smaller than 150 μm.

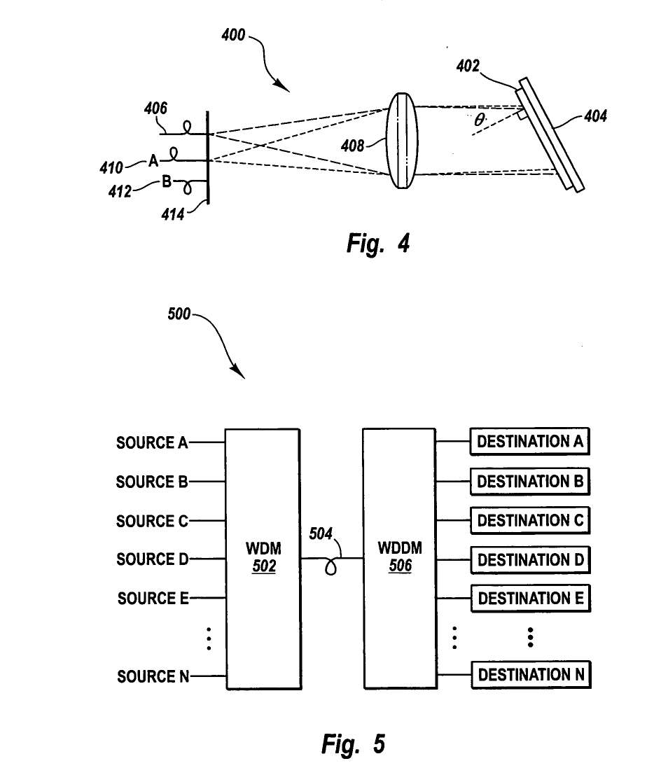

FIG. 4 illustrates one embodiment of an optical system operable as a wavelength division demultiplexer (WDDM) module employing tapered core single mode optical fibers according to teachings of the present invention. A WDDM illustrated generally at 400, includes a diffraction grating 402 coupled to a grating mount 404. Diffraction grating 402 is optically coupled to input fiber 406 via lens assembly 408. A fiber mount, not shown in FIG. 4, such as but not limited to a v-groove plate or other fiber mount known to those skilled in the art, maintains input fiber 406, a first output fiber 410, and a second output fiber 412 within a focal plane 414.

In one embodiment of WDDM 400, input fiber 406, first output fiber 410, and second output fiber 412 may include single mode optical fibers having expanded cores for communicating optical signals. Each fiber, in this illustrative configuration, may include an end portion, such as third portion 310 (FIG. 3), with a core diameter of approximately 40 μm, with adjacent fibers being spaced about 150 μm apart. Other embodiments of the present invention may include expanded-core fibers with diameters ranging from 12 to more than 40 μm. Further, the output fibers may typically be spaced about 150 μm apart.

The optical signals communicated from input fiber 406 to grating 402 may be separated into associated spectral components and communicated to each respective output fiber. In this manner, an increased spectral bandwidth can be received by each of the output fibers 410 and 412. Additionally, a decrease in noise or crosstalk between fibers 406, 410, and 412 may be realized in response to providing an increased fill factor for single mode fibers used within WDDM 400.

FIG. 5 illustrates a communications network operable to communicate signals using optical modules employing expanded core optical fibers according to teachings of the present invention. The network, illustrated generally at 500, may be realized in whole or in part, as several types of communications networks that may include wide area networks, interstate or regional networks, local area networks or other networks using optical devices or systems employing single mode expanded core fibers for communicating optical signals. Network 500 includes a WDM 502 operable to multiplex signals from sources A-N. Optical signals may be multiplexed and communicated via optical fiber 504 to WDDM 506 operable to demultiplex optical signals. Upon WDDM 506 demultiplexing optical signals, each demultiplexed signal may be communicated to a respective destination such as destinations A-N.

During use, optical signals may be communicated between initiating and destination points using one or more optical components employing optical systems having z optical fibers with expanded cores or increased relative core diameters. By employing optical fibers having expanded optical cores, increased fill factors may be realized. As such, network 500 employing devices, systems, components, etc. with expanded core optical fibers may realize a reduction in signal loss resulting in increased efficiency for communicating information via network 500.

Additionally, other optical components employing fibers and single mode fibers with expanded cores or optically increased core diameters may be used within network 500. For example, an optical switch or optical filters (not expressly show) may benefit from using single mode optical fibers or expansion modules, and/or optical lenses having increased relative cores for communicating optical signals. An electro-optic or thermo-optic switch may employ optical fibers having expanded cores for efficiently communicating optical signals while reducing undesirable losses from the use of standard single mode fibers. Such losses result from diffraction, aberrations and misalignment, and are more likely to occur for fibers with unexpanded cores.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their-scope.

What is claimed:

1. An optical system comprising:
a wavelength division demultiplexer module (WDDM) having at least one lens optically coupled to at least one diffraction grating;
a first output optical fiber having an end in close proximity to the wavelength division demultiplexer module, the end of the first output optical fiber having an expanded core diameter portion and a non-expanded core diameter portion; and
a second output optical fiber having an end in close proximity to the wavelength division demultiplexer module, the end of the second output optical fiber having an expanded core diameter portion and a non-expanded core diameter portion,
wherein the end of the first output optical fiber is separated from the end of the second output optical fiber by an inter-fiber distance operable to maintain a defined fill factor for a wavelength of an optical signal propagating along at least one of the first output optical fiber and second output optical fiber.

2. The system as recited in claim 1, wherein the non-expanded core diameter portion of the first output optical fiber and the second output optical fiber has a diameter of about 8 μm.

3. The system as recited in claim 1, wherein the expanded core diameter portion of the first output optical fiber and the second output optical fiber has a diameter of about 15 μm to 45 μm.

4. The system as recited in claim 1, wherein the expanded core diameter portion of the end of the first output optical fiber and the second output optical fiber comprises a tapered core fiber portion.

5. The system as recited in claim 1, wherein the first output fiber is a single mode optical fiber.

6. The system as recited in claim 1, further comprising a mount operable to position the first output optical fiber and the second output optical fiber.

7. The system as recited in claim 1, wherein the defined fill factor for communicating the optical signal is greater than achievable using a standard first optical fiber and a second optical fiber without expanded cores.

8. The system as recited in claim 1, wherein the fill factor has a value of at least 20 percent.

9. The system as recited in claim 1, wherein the inter-fiber distance between the first output optical fiber and the second output optical fiber is greater than about 125 μm.

10. The system as recited in claim 1, wherein the inter-fiber distance between the first output optical fiber and the second output optical fibers is about 150 μm.

11. An optical system comprising:
a wavelength division multiplexer module (WDM) having at least one lens optically coupled to at least one diffraction grating;
a first input optical fiber having an end in close proximity to the wavelength division multiplexer module, the end of the first input optical fiber having an expanded core diameter portion; and
a second input optical fiber having an end in close proximity to the wavelength division multiplexer module, the end of the second input optical fiber having an expanded core diameter portion and a non-expanded core diameter portion,
wherein the end of the first input optical fiber is separated from the end of the second input optical fiber an inter-fiber distance operable to maintain a defined fill factor for a wavelength of an optical signal propagating along at least one of the first input optical fiber and second input optical fiber.

12. The system as recited in claim 11, wherein the non-expanded core diameter portion of the first input optical fiber and the second input optical fiber has a diameter of about 8 μm.

13. The system as recited in claim 11, wherein the expanded core diameter portion of the first input optical fiber and the second input optical fiber has a diameter of about 15 μm to 45 μm.

14. The system as recited in claim 11, wherein the expanded core diameter portion of the end of the first input optical fiber and the second input optical fiber comprises a tapered core fiber portion.

15. The system as recited in claim 11, wherein the first output fiber is a single mode optical fiber.

16. The system as recited in claim 11, further comprising a mount operable to position the first input optical fiber and the second input optical fiber.

17. The system as recited in claim 11, wherein the defined fill factor for communicating the optical signal is greater than achievable using a standard first optical fiber and a second optical fiber without expanded cores. . * , i :.

18. The system as recited in claim 11, wherein the fill factor has a value of at least 20 percent.

19. The system as recited in claim 11, wherein the inter-fiber distance between the first input optical fiber and the second input optical fiber is greater than about 125 μm.

20. The system as recited in claim 11, wherein the inter-fiber distance between the first input optical fiber and the second input optical fibers is about 150 μm.
